(19) United States
(12) Patent Application Publication
(10) Pub. No.: US 2014/0017399 A1
(43) Pub. Date: Jan. 16, 2014

(54) ABRASION-RESISTANT AND SCRATCH-RESISTANT COATINGS HAVING A LOW INDEX OF REFRACTION ON A SUBSTRATE

(71) Applicants: Heike ARNDT, Moemlingen (DE); Mohammad JILAVI, Kirkel (DE); Martin MENNIG, Quierschied (DE); Peter William OLIVEIRA, Saarbruecken (DE); Helmut SCHMIDT, Saarbruecken-Guedingen (DE)

(72) Inventors: Heike ARNDT, Moemlingen (DE); Mohammad JILAVI, Kirkel (DE); Martin MENNIG, Quierschied (DE); Peter William OLIVEIRA, Saarbruecken (DE); Helmut SCHMIDT, Saarbruecken-Guedingen (DE)

(73) Assignee: LEIBNIZ-INSTITUT FUER NEUE NEMATERIALIEN GEMEINNUETZIGE GMBH, Saarbruecken (DE)

(21) Appl. No.: 14/029,971

(22) Filed: Sep. 18, 2013

Related U.S. Application Data
(62) Division of application No. 11/570,112, filed on Mar. 9, 2007.

(30) Foreign Application Priority Data
Jun. 8, 2004 (DE) 102004027842.3

(51) Int. Cl. G02B 1/10

(52) U.S. Cl. CPC G02B 1/10
USPC 427/162; 106/286.6; 106/287.27; 106/287.26

(57) ABSTRACT

Disclosed is a substrate with an abrasion resistant and scratch-resistant coating that has a low index of refraction and comprises magnesium fluoride and at least one metal oxide or semimetal oxide. The coating can be obtained by applying a coating composition containing magnesium fluoride or a precursor thereof and at least one metal oxide or semimetal oxide, or a precursor thereof onto a substrate and then subjecting the same to a thermal treatment.

### CROSS-REFERENCE TO RELATED APPLICATIONS

The present application is a divisional of U.S. patent application Ser. No. 11/570,112, which is a U.S. National Stage of International Application PCT/EP2005/006113, filed Jun. 7, 2005, which claims priority under 35 U.S.C. §119 of German Patent Application No. 10 2004 027 842.3, filed Jun. 8, 2004. The entire disclosure of the parent application is expressly incorporated by reference herein.

### BACKGROUND OF THE INVENTION

1. Field of the Invention

The invention relates to a substrate having an abrasion- and scratch-resistant coating with low refractive index, comprising magnesium fluoride and at least one metal oxide or semimetal oxide, to a process for its preparation and to its use, and to the coating composition used for the process and to its preparation.

2. Discussion of Background Information

Many fluorides of alkaline earth metals, especially magnesium fluoride (MgF₂) feature a low refractive index and are therefore of great interest as materials for dielectric multiple coatings and particularly for antireflection coatings. These materials are used both as components in multilayer systems and as monolayers. The λ/4 antireflection monolayer used is in particular magnesium fluoride.

In general, thin MgF₂ layers are obtained by means of complicated and expensive PVD and CVD processes or sputtering. The disadvantage of these processes is that the coating of large substrates becomes very laborious and costly, and curved substrates cannot be coated homogeneously. Moreover, good abrasion resistance cannot be achieved. A further disadvantage of the layers thus obtained is that they are generally very dense and therefore have a refractive index approximating to that of the bulk material (n=1.38). This refractive index is sufficiently low to be used in multilayer systems. In order, however, to be able to achieve optimal antireflection properties on common substrates with a refractive index of approx. 1.5 (e.g. glass), an antireflection monolayer must ideally have a refractive index of n=1.22

(n_{layer}˜\sqrt{n_{substrate}·nₐᵢᵣ}=\sqrt{1.5}=1.22)

One means of lowering the refractive index of a layer consists in increasing its porosity. This can be achieved by applying the MgF₂ layers by wet chemical means.

EP-A-0641739 describes the synthesis of sodium magnesium fluoride sols (NaF.MgF₂). In this synthesis, aqueous sodium fluoride and magnesium salt solutions are mixed and the by-product salts formed are then removed by complicated filtration processes. The resulting aggregates of the colloidal particles are finally wet-ground. In order to obtain antireflection coating materials, the NaF.MgF₂ sols, after a solvent exchange, are mixed with film forming agents and applied to glass. However, the transmission of the coated glasses is only 94.05% (550 nm) compared to 91.61% (550 nm) for the uncoated glass. In addition to the complicated synthesis of the coating material, the insufficient antireflective action of these layers in particular is disadvantageous.

Magnesium fluoride sols are prepared in a similar manner in JP-A-2026824. Here too, aqueous magnesium salt solutions are mixed with aqueous fluoride solutions and heated. Here too, by-product salts have to be removed by means of ultrafiltration.

Thin layers having a refractive index of n=1.16 (193 nm) on optical substrates lead, according to EP-A-1 316 005, to a transmission loss of less than 0.5%. The layers are obtained by applying an MgF₂ sol. The MgF₂ sol is obtained by reacting magnesium acetate with hydrofluoric acid in methanol and then autoclaved.

I. M. Thomas, Applied Optics 27 (1988) 3356-3358, also describes the formation of magnesium fluoride sols by reacting magnesium acetate tetrahydrate or magnesium methoxide with hydrofluoric acid in dry methanol. Quartz glass which is coated with these sols exhibits a transmission of approximately 100% (˜350 nm), i.e. the refractive index of these layers is approx. 1.2. Thus, although antireflection layers with the desired optical properties are obtainable, an immense disadvantage of this method is the use of hydrofluoric acid (HF), since hydrofluoric acid is highly toxic.

A sol-gel route to the preparation of magnesium fluoride using nontoxic starting materials is described in EP-A-071348. For example, magnesium is dissolved in an anhydrous solvent and reacted with fluorinated alcohols to give the fluoroalkoxide. Filtration of the solution is followed by the hydrolysis of the magnesium alkoxides. Although this process has the advantage that the starting materials are nontoxic, harmless reactants, the reactants such as anhydrous solvents and fluorinated alcohols are expensive. In addition, this patent application does not contain any data concerning the optical or mechanical properties of layers which are obtainable by immersion coating, for example on glass, of the above-described sols.

A further method for obtaining magnesium fluoride layers in which nontoxic starting materials are used is described in U.S. Pat. No. 4,493,2721. There, magnesium fluoride layers are obtained by the thermal disproportionation of fluorine-containing magnesium compounds such as magnesium trifluoroacetate, magnesium trifluoroacetylacetonate or magnesium hexafluoroacetylacetonate. The compounds mentioned are dissolved in organic solvents such as butyl acetate or ethylene glycol monoethyl ether, applied by means of spin-coating, spraying or dipping to substrates (glass, quartz glass), and cured at at least 300° C. for at least 1 min. The layers thus obtained have a refractive index of from 1.36 to 1.38 and are hence within the range of the bulk material. Nevertheless, glass substrates thus coated have a residual reflection of 0.5%.

Magnesium fluoride layers are obtained in a similar manner according to S. Fujihara et al., Journal of Sol-Gel-Science and Technology 19 (2000) 311-314. One route includes the reaction of magnesium acetate with trifluoroacetic acid (TFA) and water in 2-propanol. The application of these sols to quartz glass by means of spin-coating and subsequent curing of the layers at from 400 to 500° C. gives rise to layers whose refractive index is within the desired range (n=1.2). However, in-house investigations have shown that serious wetting problems occur in the application of the sols prepared by this method.

When, in contrast, magnesium ethoxide (Mg(OEt)₂) is reacted with trifluoroacetic acid (TFA) in 2-propanol to give magnesium trifluoroacetate (S. Fujihara et al., Thin Solid Films 304 (1997) 252-255), in-house investigations show that there are rarely wetting problems in the application. The sols prepared in this way were, according to this reference, applied to quartz glass by means of spin-coating and cured at temperatures of from 300° C. to 600° C. for 10 min. The substrates thus coated exhibit a relatively low transmission of not more than approx. 96.6%. There is a lack of data on the refractive index of these layers.

It is known that sols of metal oxides or semimetal oxides for layers composed of metal oxides or semimetal oxides, such as ZrO₂, Al₂O₃, TiO₂, Ta₂O₅ or SiO₂ layers, can give rise to coatings with good optical quality, but their refractive index is significantly higher (from 1.46 to 2.3) than that of MgF₂ layers.

### SUMMARY OF THE INVENTION

It is an object of the invention, using nontoxic or only slightly toxic starting materials, to provide a wet-chemical synthesis route for low-refractive index optical layers which feature good optical quality and in particular low refractive index. Moreover, abrasion resistance of these layers over and above that of the prior art should be achieved.

The object is surprisingly achieved by a coating composition which comprises magnesium fluoride or a precursor thereof and at least one metal oxide or semimetal oxide or a precursor thereof. The inventive coating composition can be applied to a substrate by wet-chemical means in a simple manner, and cured and consolidated by heat treatment. The invention thus also provides a substrate with an abrasion- and scratch-resistant coating with low refractive index, comprising magnesium fluoride and at least one metal oxide or semimetal oxide.

Unexpectedly, it has been found that the inventive preparation route does not result in any significant increase in the refractive index of the magnesium fluoride-semimetal/metal oxide layers compared to pure magnesium fluoride layers, but their scratch resistance increases significantly.

The coating composition comprises magnesium fluoride or a precursor thereof and at least one metal oxide or semimetal oxide or a precursor thereof. The at least one metal oxide or semimetal oxide or a precursor thereof in the coating composition is preferably present in the form of a sol, i.e. the coating composition is preferably a coating sol. The magnesium fluoride or a precursor thereof may be present in the form of a sol or as a solution. The coating composition is preferably prepared by mixing a sol or a solution of magnesium fluoride or of a precursor thereof and a sol of at least one metal oxide or semimetal oxide or a precursor thereof with one another.

The sol or the solution of the magnesium fluoride or of a precursor thereof may be prepared in any of the ways known from the prior art, some of which have been detailed above. The sol or the solution is preferably obtained from the reaction of a magnesium compound, preferably of a hydrolyzable magnesium compound, with a fluorinated organic compound, the reaction commonly being performed in an organic solvent. “Hydrolyzable” is also understood here to mean the hydratability of the magnesium compound.

What is meant by a precursor here is in particular compounds of magnesium which can be converted to MgF₂, especially under the conditions for preparing the inventive substrate, such as in the heat treatment. For example, magnesium compounds or complexes of fluorinated organic compounds can be converted to magnesium fluoride by a thermal disproportionation reaction. If appropriate, disproportionation reactions or the conversion to MgF₂ are effected actually at room temperature, so that MgF₂ may also be present in the sol or the solution. Of course, the mixture of magnesium compound and fluorinated compound may also be heated if appropriate, for instance in order to promote the conversion to MgF₂ in the sol or the solution.

Suitable magnesium compounds are all compounds which can be reacted with a fluorinated organic compound, in particular hydrolyzable magnesium compounds. Examples are magnesium alkoxides. The alkoxy group of the magnesium alkoxide has preferably from 1 to 12 carbon atoms, preference being given to magnesium methoxide, magnesium ethoxide, magnesium propoxide and magnesium butoxide. The most preferred compound is magnesium ethoxide (Mg(OEt)₂). The alkoxide may be linear or branched, for example n-propoxide or isopropoxide.

The fluorinated organic compound used is preferably an organic compound with a CF₃ group. Organic compounds used with preference are ketones, especially β-diketones, and carboxylic acids. Examples are trifluoroacetylacetone, hexafluoroacetylacetone and trifluoroacetic acid, particular preference being given to trifluoroacetic acid.

The solvent used may be any suitable solvent, for example one of those mentioned below for the preparation of metal oxides or semimetal oxides. Appropriate solvents are, e.g., alcohols. Examples are ethanol, n-propanol, 2-propanol or butanol.

A preferred preparation route for the sol or the solution comprising magnesium fluoride or a precursor thereof can be described as follows. A hydrolyzable magnesium compound, preferably magnesium alkoxide, more preferably magnesium ethoxide, is dispersed in an organic solvent, preferably an alcohol, more preferably 2-propanol, and then reacted with an organic compound which contains at least one CF₃ group. For this purpose, preference is given to using ketones and carboxylic acids which contain CF₃ groups, especially trifluoroacetic acid. Subsequently, any undissolved constituents present are filtered off.

The metal oxides or semimetal oxides used may be all oxides of metals or semimetals (also abbreviated hereinafter collectively as M). In particular, oxides of metals or semimetals of main groups III to VI, especially of main groups III and IV, and/or of the transition groups, preferably of transition groups II to V, of the Periodic Table of the Elements, and also lanthanides and actinides or mixed oxides thereof are used. Preferred metals or semimetals M for the metal oxides or semimetal oxides are, for example, B, Al, Ga, In, Si, Ge, Sn, Pb, Y, Ti, Zr, V, Nb, Ta, Mo, W, Fe, Cu, Ag, Zn, Cd, Ce and La, or mixed oxides thereof. It is possible to use one type of oxide or a mixture of oxides.

Examples of oxides which may optionally be hydrated are ZnO, CdO, SiO₂, GeO₂, TiO₂, ZrO₂, CeO₂, SnO₂, Al₂O₃ (boehmite, AlO(OH), also known as aluminum hydroxide, B₂O₃, In₂O₃, La₂O₃, Fe₂O₃, Fe₃O₄, Cu₂O, Ta₂O₅, Nb₂O₅, V₂O₅, MoO₃ or WO₃. It is also possible to use silicates, zirconates, aluminates, stannates of metals or semimetals, and mixed oxides such as indium tin oxide (ITO), antimony tin oxide (ATO), fluorine-doped tin oxide (FTO), luminescent pigments comprising Y- or Eu-containing compounds, spinels, ferrites or mixed oxides with perovskite structure, such as BaTiO₃ and PbTiO₃.

Preference is given to semimetal oxides or metal oxides, which are optionally hydrated (oxide hydrate), of Si, Ge, Al, B, Zn, Cd, Ti, Zr, Ce, Sn, In, La, Fe, Cu, Ta, Nb, V, Mo or W. Particular preference is given to SiO₂, Al₂O₃, Ta₂O₅, ZrO₂ and TiO₂, of which ZrO₂ is the most preferred.

The sol of at least one semimetal oxide or metal oxide can be prepared by dispersing particles prepared, especially nanoscale particles, in a solvent or in situ. The particles can usually be prepared in various ways, for example by flame pyrolysis, plasma processes, colloid techniques, sol-gel processes, controlled nucleation and growth processes, MOCVD processes and emulsion processes. These processes are described in detail in the literature.

The sol of at least one semimetal oxide or metal oxide is preferably prepared by a sol-gel process. In the sol-gel process, usually hydrolyzable compounds are hydrolyzed with water, if appropriate with acidic or basic catalysis, and at least partly condensed if appropriate. The hydrolysis and/or condensation reactions lead to the formation of compounds or condensates with hydroxyl, oxo groups and/or oxo bridges, which serve as intermediates. Suitable adjustment of the parameters, for example degree of condensation, solvent, temperature, water concentration, duration or pH, allows the sol comprising the oxides or precursors to be obtained. The precursors of the oxides are understood to mean in particular the condensation products mentioned. Further details of the sol-gel process are described, for example, in C. J. Brinker, G. W. Scherer; “Sol-Gel Science—The Physics and Chemistry of Sol-Gel-Processing”, Academic Press, Boston, San Diego, New York, Sydney (1990).

The hydrolysis and condensation can be performed in a solvent, but they can also be performed without solvent, in which case solvents or other liquid constituents can be formed in the hydrolysis.

Useable solvents include both water and organic solvents or mixtures. These are the customary solvents used in the field of coating. Examples of suitable organic solvents are alcohols, preferably lower aliphatic alcohols (see C₁-C₈-alcohols), such as methanol, ethanol, 1-propanol, isopropanol and 1-butanol, ketones, preferably lower dialkyl ketones such as acetone and methyl isobutyl ketone, ethers, preferably lower dialkyl ethers, such as diethyl ether, or diol monoethers, amides such as dimethylformamide, tetrahydrofuran, dioxane, sulfoxides, sulfones or butylglycol, and mixtures thereof. Preference is given to using alcohols. It is also possible to use high-boiling solvents. In the sol-gel process, the solvents may optionally be an alcohol formed in the hydrolysis from the alkoxide compounds.

Suitable hydrolyzable compounds are in principle all hydrolyzable metal or semimetal compounds, for example the metals and semimetals M listed above. It is possible to use one or more hydrolyzable compounds.

The hydrolyzable metal or semimetal compound is preferably a compound of the general formula MXₙ (I) in which M is the above-described metal or semimetal, X is a hydrolyzable group which may be the same or different, where two X groups may be replaced by a bidentate hydrolyzable group or an oxo group or three X groups may be replaced by a tridentate hydrolyzable group, and n corresponds to the valency of the element when X has a charge of 1, and is frequently 3 or 4. Optionally, the hydrolyzable compound may also have unhydrolyzable groups which replace some of the hydrolyzable groups.

Examples of the hydrolyzable X groups which may be the same or different from one another are hydrogen, halogen (F, Cl, Br or I, in particular Cl or Br), alkoxy (e.g. C₁₋₆-alkoxy, for example methoxy, ethoxy, n-propoxy, i-propoxy and n-, i-, sec- or tert-butoxy), aryloxy (preferably C₆₋₁₀-aryloxy, for example phenoxy), alkaryloxy, e.g. benzyloxy, acyloxy (e.g. C₁₋₆-acyloxy, preferably C₁₋₄-acyloxy, for example acetoxy or propionyloxy), amino and alkylcarbonyl (e.g. C₂₋₇-alkylcarbonyl such as acetyl), or complexing agents such as β-dicarbonyls (e.g. acetylacetonato). The groups mentioned may optionally contain substituents, such as halogen or alkoxy. Preferred hydrolyzable X radicals are halogen, alkoxy groups and acyloxy groups, particular preference being given to alkoxides. The compounds may also be stabilized with additional complexing compounds.

Examples of titanium compounds of the formula TiX₄ are TiCl₄, Ti(OCH₃)₄, Ti(OC₂H₅)₄, Ti(pentoxy)₄, Ti(hexoxy)₄, Ti(2-ethylhexoxy)₄, Ti(n-OC₃H₇)₄ or Ti(i-OC₃H₇)₄. Further examples of useable hydrolyzable compounds of elements M are Al(OCH₃)₃, Al(OC₂H₅)₃, Al(O-n-C₃H₇)₃, Al(O-i-C₃H₇)₃, Al(O-n-C₄H₉)₃, Al(O-sec-C₄H₉)₃, AlCl₃, AlCl(OH)₂, Al(OC₂H₄OC₄H₉)₃, ZrCl₄, Zr(OC₂H₅)₄, Zr (O-n-C₃H₇)₄, Zr (O-i-C₃H₇)₄, Zr(OC₄H₉)₄, ZrOCl₂, Zr(pentoxy)₄, Zr(hexoxy)₄, Zr(2-ethylhexoxy)₄, and Zr compounds which have complexing radicals, for example β-diketone and (meth)acryloyl radicals, boric acid, BCl₃, B(OCH₃)₃, B(OC₂H₅)₃, SnCl₄, Sn(OCH₃)₄, Sn(0C₂H₅)₄, VOCl₃ and VO(OCH₃)₃, Examples of silanes of the formula SiX₄ are Si(OCH₃)₄, Si(OC₂H₅)₄, Si(O-n- or -i-C₃H₇)₄, Si(OC₄H₉)₄, SiCl₄, HSiCl₃, Si(OOCCH₃)₄. Among these silanes, preference is given to tetraalkoxysilanes, particular preference being given to those with C₁-C₄-alkoxy, in particular tetramethoxysilane and tetraethoxysilane (TEOS).

If appropriate, the semimetal oxides or metal oxides can also be prepared in the presence of a complexing agent. Examples of suitable complexing agents are, for example, unsaturated carboxylic acids and β-dicarbonyl compounds, for example (meth)acrylic acid, acetylacetone and ethyl acetoacetate.

In addition, an adhesion promoter can also be used if appropriate, which usually interacts, or is bound or complexed, with the particle of semimetal oxide or metal oxide or the precursor thereof, surface-modifying the particle and hence promoting adhesion on the substrate. In addition to the group for the attachment to the semimetal oxide or metal oxide or the precursor thereof, the adhesion promoter preferably has a further functional group. Complexing agents may also be suitable as adhesion promoters.

Examples of an adhesion promoter are unsaturated carboxylic acids such as (meth)acrylic acid and a hydrolyzable silane having at least one unhydrolyzable group, the silane being suitable in particular for sols of SiO₂.

Examples of hydrolyzable silanes having at least one unhydrolyzable group as an adhesion promoter are compounds of the formula RSiX₃ (II) in which X is as defined in formula (I). The unhydrolyzable R radical may be unhydrolyzable R radicals without a functional group or preferably with a functional group.

The unhydrolyzable R radical is, for example, alkyl (preferably C₁₋₈-alkyl), alkenyl (preferably C₂₋₆-alkenyl), alkynyl (preferably C₂₋₆-alkynyl) and aryl (preferably C₆₋₁₀-aryl). The R and X radicals may optionally have one or more customary substituents, for example halogen or alkoxy. Specific examples of the functional groups of the R radical are the epoxy, hydroxyl, ether, amino, monoalkylamino, dialkylamino, amide, carboxyl, vinyl, acryloyloxy, methacryloyloxy, cyano, halogen, aldehyde, alkylcarbonyl and phosphoric acid groups. These functional groups are bonded to the silicon atom via alkylene, alkenylene or arylene bridging groups which may be interrupted by oxygen or —NH groups. The bridging groups mentioned derive, for example, from the abovementioned alkyl, alkenyl or aryl radicals. The R radicals having a functional group contain preferably from 1 to 18 carbon atoms, in particular from 1 to 8 carbon atoms.

Examples of silanes of the formula (II) are hydrolyzable silanes having a glycidyloxy group, amino group or (meth)acryloyloxy groups, such as γ-glycidyl-oxypropyl-trimethoxysilane, γ-glycidyloxypropyltriethoxysilane, 3-(meth)acryloyloxypropyltri(m)ethoxysilane, 3-(meth)acryl-oyloxypropyltrimethoxysilane, 3-aminopropyltriethoxy-silane, N-2-aminoethyl-3-aminopropyltrimethoxysilane, trimethoxysilylpropyldiethylenetriamine. (Meth)acryloyl represents methacryloyl or acryloyl. Further specific examples of hydrolyzable silanes with unhydrolyzable groups can be taken, for example, from EP-A-195493. The surface modification of nanoscale particles is a known process, as described by the applicant, for example, in WO 93/21127 (DE 4212633) or WO 96/31572.

The semimetal oxide or metal oxide sol is thus preferably synthesized from the corresponding hydrolyzable compound, preferably from the metal alkoxide, by hydrolysis, optionally in the presence of a catalyst and/or complexing agent. Preference is given to using ZrO₂ sols, which can be prepared, for example, from zirconium tetra-n-propoxide by reaction with hydrochloric acid in the presence of acetylacetone.

Subsequently, the sol of the at least one metal oxide or semimetal oxide or precursors thereof is mixed with the solution or the sol of magnesium fluoride or precursors thereof. The ratio can be varied within wide ranges. In general, the amounts are, though, selected such that the quantitative ratio of the amount of magnesium (Mg) in magnesium fluoride or precursors thereof to metal or semimetal (M) in the at least one metal oxide or semimetal oxide or precursors thereof. Mg/M in the coating composition is in the range from 1:0.01 to 1:1.8, more preferably in the range from 1:0.05 to 1:0.5 or from 1:0.1 to 1:0.5 and especially preferably from 1:0.1 to 1:0.2.

In addition to magnesium fluoride or precursors thereof and the at least one metal or semimetal oxide or precursors thereof, the solvent(s) and if appropriate complexing agents or adhesion promoters, the coating composition preferably essentially does not comprise any further components. It is, though, conceivable to add other additives.

Magnesium fluoride or precursors thereof and the at least one metal oxide or semimetal oxide or precursors thereof make up preferably at least 80% by weight, more preferably at least 90% by weight and especially preferably at least 95% by weight of the solids content of the coating composition. The proportion of magnesium fluoride or precursors thereof is preferably at least 10% by weight, more preferably at least 20% by weight and especially preferably at least 30% by weight, based on the solids content of the coating composition.

The coating composition is applied to a substrate. In principle, all substrates are possible. Examples of a suitable substrate are substrates of metal, semiconductor, glass, ceramic, glass ceramic, plastic, crystalline substrates or inorganic-organic composite materials. Preference is given to using substrates which are stable with respect to a thermal treatment of the coating. The substrates may be pretreated, for example for cleaning, by a corona treatment or with a preliminary coating (for example a varnish or a metallized surface).

The resulting layers are used in particular for optical coatings, or optical or optoelectronic applications. Preferred substrates are especially those which are translucent at least in a certain range or in certain ranges of the light spectrum from UV light through visible light to infrared light. Transparent substrates with translucence in the region of visible light are particularly appropriate.

Examples of plastics substrates are polycarbonate, polymethyl methacrylate, polyacrylates, polyethylene terephthalate. Preference is given to transparent plastics, glasses (e.g. silicatic glasses such as window glass or optical glasses, silica glass, quartz glass, borosilicate glass or soda-lime silicate glass, chalcogenide or halide glasses, etc.) and crystalline substrates (e.g. sapphire, silicon or lithium niobate).

Suitable substrates for optical applications are, for example, plate glass, watchglasses, instrument covers, lenses and other optical elements, polymer films or transparent vessels.

The coating processes used may be all common wet-chemical methods for producing optical layers, for example dip-coating, spin-coating, spray processes, roll-coating techniques or combinations thereof, and also common printing processes, for example screenprinting, flexographic printing or pad printing. Further coating processes are knife-coating, casting, spreading, flow-coating, slot-coating, meniscus-coating or curtain-coating.

Drying of the applied coating composition is followed by thermal aftertreatment of the coating, for example above 50° C. The temperature used can vary within wide ranges; preference is given to effecting thermal treatment in the temperature range of from 100° C. to 600° C., more preferably of from 300 to 500° C., especially preferably from 400 to 450° C. The selection of the temperature allows the optical properties (for example reflection, refractive index) and the mechanical properties to be controlled. They depend upon the optical properties of the substrate (refractive index), on the intended optical purpose (antireflection coating, interference layer assembly), on the thermal stability of the substrate and on the desired use (external application, internal application). The heat treatment can, for example, cure and consolidate and/or convert the precursors to MgF₂ or the oxide.

The ratio of Mg to metal or semimetal in the finished layer corresponds at least approximately to the ratio in the coating composition. As is the case there, the ratio can vary within wide ranges. In general, the quantitative ratio of magnesium (Mg) in magnesium fluoride to metal or semimetal (M) in the at least one metal oxide or semimetal oxide in the coating is in the range from 1:0.01 to 1:1.8, more preferably in the range from 1:0.05 to 1:0.5 or from 1:0.1 to 1:0.5 and especially preferably from 1:0.1 to 1:0.2.

The layers consist preferably essentially of MgF₂ and the at least one semimetal oxide or metal oxide. If appropriate, for example, the aforementioned complexing agents or adhesion promoters or other additives may be present in relatively small amounts in the finished composition. Organic components used, such as complexing agents or adhesion promoter, may be volatile in the heat treatment or be burnt out. The layers are therefore usually for the most part or essentially inorganic layers.

Magnesium fluoride and the at least one metal oxide or semimetal oxide make up preferably at least 80% by weight, more preferably at least 90% by weight and especially preferably at least 95% by weight of the coating. The proportion of magnesium fluoride in the coating is preferably at least 10% by weight, more preferably at least 20% by weight and especially preferably at least 30% by weight.

The layer thickness may vary within wide ranges, but is usually within the range from 20 nm to 1 μm, preferably from 30 to 500 nm and more preferably from 50 to 250 nm.

The inventive coating may be used in the form of an individual layer or in the form of one layer of a multilayer assembly. The other layers may be identical layers, optionally with different ratios, or other, usually likewise optical layers. Accordingly, further layers may be applied to the substrate in a customary manner before and/or after the coating.

In general, the coating is used as an optical coating. The coating is suitable in particular for antireflection coatings, especially as an individual layer, and for interference layer assemblies. These antireflection and interference layers are preferably used on transparent substrates or substrates which are translucent in at least one region of the wavelength range from UV light to IR light.

### BRIEF DESCRIPTION OF THE DRAWINGS

The present invention is further described in the detailed description which follows, in reference to the noted plurality of drawings by way of non-limiting examples of exemplary embodiments of the present invention, wherein:

FIG. 1 is graph which shows the transmission in % as a function of the wavelength in nm for coatings made from the coating compositions of Example 1;

FIG. 2 is graph which shows the transmission in % as a function of the wavelength in nm for coatings made from the coating compositions of Example 2; and

FIG. 3 is graph which shows the transmission in % as a function of the wavelength in nm for coatings made from the coating compositions of Example 3.

### DETAILED DESCRIPTION OF THE INVENTION

The examples which follow illustrate the invention further without restricting it. The solution or the sol comprising MgF₂ or precursors thereof is referred to in simplified terms as the MgF₂ sol, even when it should be a solution of MgF₂ precursors.

### EXAMPLES

### A) Preparation of the Sols

MgF₂ sol: 25.396 g (0.22 mol) of magnesium ethoxide are added at room temperature to 522.810 g of 2-propanol. 51.016 g (0.35 mol) of trifluoroacetic acid (TFA) are added to the stirred dispersion and stirred at room temperature. At the start of the reaction, slight heating of the reaction mixture is observed. With progressing reaction, increasing clarification of the reaction mixture is observed. After 2 h, any insoluble constituents present are removed by means of a syringe filter (1.2 μm), and then the reaction mixture is left to stand at room temperature. A colorless precipitate forms overnight and is removed by means of a fluted filter. The filtrate is filtered again through a 1.2 μm syringe filter, resulting in a yellow solution. The coating composition is storage-stable for at least 4 weeks at room temperature.

SiO₂ sol: 13.29 g (87.3 mmol) of tetramethoxysilane (TMOS) are dissolved at room temperature in 11.80 g of ethanol. A mixture of 13.40 g (744.4 mmol) of water, 0.30 g of hydrochloric acid (37%) and 11.80 g of ethanol is added with stirring. The mixture is stirred at room temperature for at least 2 h (brief heating of the reaction mixture after addition) and diluted with 130 g of 2-propanol. Immediately after the dilution, 0.30 g (1.52 mmol) of 3-glycidyloxypropyltrimethoxy-silane (GPTS) and 18 mg (0.08 mmol) of 3-aminopropyl-triethoxysilane in 26 g of 2-propanol are added with stirring. The mixture is stirred at room temperature for 1 h, resulting in a colorless, clear sol which is storage stable for at least 4 weeks at 4° C.

Al₂O₃ sol: 40 g (0.16 mol) of aluminum tri-sec-butoxide are dissolved at room temperature in 240 g of 2-propanol with stirring. 8 g (0.08 mol) of acetylacetone and 3.2 g (0.18 mol) of water are added with stirring. The mixture is filtered at room temperature for 1 h and filtered through a 0.45 μm syringe filter. This results in a yellow, clear sol.

ZrO₂ sol: 24 g (51.3 mmol) of zirconium tetra-n-propoxide (70% by weight in 1-propanol) are dissolved at room temperature in 240 g of 2-propanol. 2.553 g (25.5 mmol) of acetylacetone are added with stirring and the mixture is stirred for 10 min. Subsequently, 1.8 g of concentrated hydrochloric acid are added and the mixture is stirred at room temperature for 1 h. Filtration through a 5 μm syringe filter results in a yellow, clear sol.

### B) Preparation of the MgF₂ Composites

MgF₂ composite sols are prepared by simply mixing the MgF₂ sol with the appropriate amounts of SiO₂ sol, Al₂O₃ sol or ZrO₂ sol.

### C) Coating Procedure

Soda-lime silicate glass panes are cleaned by wiping with ethanol and coated with the particular sol in a dipping process (3.5 mm/s). The coating is cured at 450° C. for 30 min.

### D) Characterization

The scratch resistance is tested with a steel wool test (0000 steel wool, 250 g/l cm², 10 cycles). The damage (number of scratches obtained) is assessed by light microscopy. The reflectance is determined spectroscopically.

### Example 1

### MgF₂/SiO₂ Composites

| MgF₂ sol/SiO₂ sol | Scratch resistance |
|---|---|
| % by wt./% by | (0000 steel wool, 250 g/1 cm², 10 |
| wt. | cycles) |
| 100/0 | Layer is rubbed off completely |
| 50/50 | ≧100 scratches |
| 40/60 | 20-50 scratches |

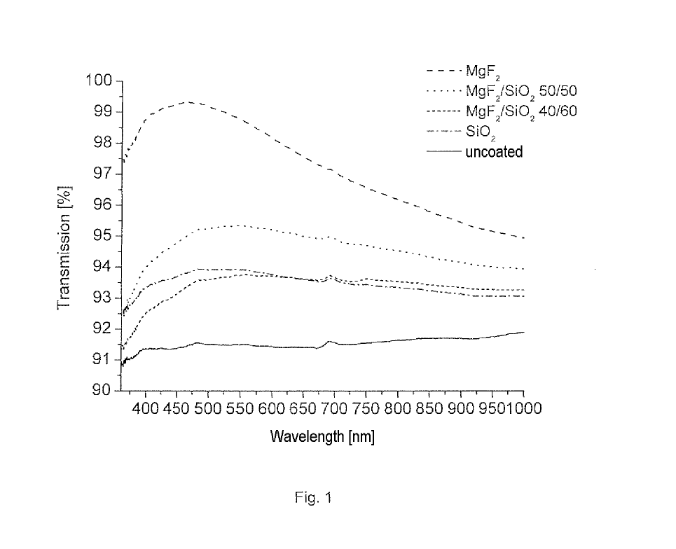

The performance of the resulting layers with regard to transmission was investigated and is reported in FIG. 1.

A distinct improvement in the scratch resistance is achieved already at a mixing ratio of MgF₂ sol/SiO₂ sol of 50/60. The transmission is higher than in the case of the uncoated glass and likewise higher than in the case of a pure SiO₂ layer.

### Example 2

### MgF₂/Al₂O₃ Composites

| MgF₂ sol/Al₂O₃ | |
|---|---|
| sol | Scratch resistance |
| % by wt./% by | (0000 steel wool, 250 g/1 cm², 10 |
| wt. | cycles) |
| 100/0 | ≧100 scratches, layer is rubbed off |
| | completely |
| 90/10 | ≧100 scratches, slight layer ruboff |
| 80/20 | approx. 20 scratches, slight layer |
| | ruboff |
| 70/30 | approx. 20 scratches, slight layer |
| | ruboff |
| 0/100 | ≧100 scratches |

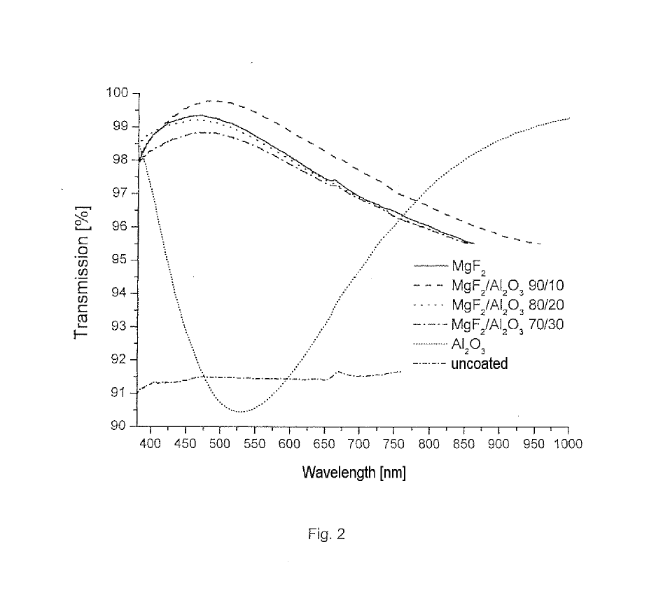

The performance of the resulting layers with regard to transmission was investigated and is reported in FIG. 2.

The scratch resistance of MgF₂ layers is improved by the addition of Al₂O₃ sols. The best performance is shown by MgF₂/Al₂O₃ mixtures of 80/20 with an improved scratch resistance at a transmission of up to approx. 99%.

### Example 3

### MgF₂/ZrO₂ Composites

| MgF₂ sol/ ZrO₂ | |
|---|---|
| sol | Scratch resistance |
| % by wt./% by | (0000 steel wool, 250 g/1 cm², 10 |
| wt. | cycles) |
| 100/0 | ≧100 scratches |
| 90/10 | ≧100 scratches, no improvement over |
| | MgF₂ |
| 80/15 | ≧100 scratches, slight improvement |
| | over MgF₂ |
| 80/20 | 0 scratches, very good scratch |
| | resistance |
| 70/30 | 0 scratches, absolutely scratch- |
| | resistant |
| 0/100 | 20-30 scratches |

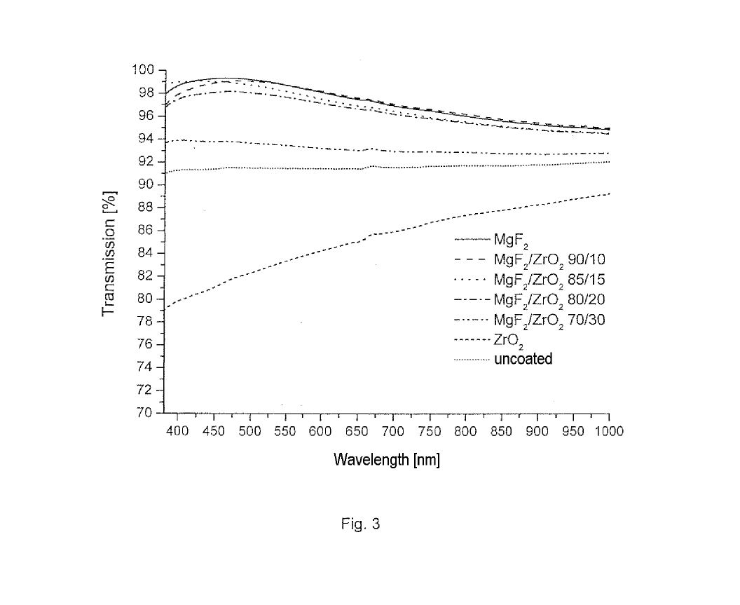

The performance of the resulting layers with regard to transmission was investigated and is reported in FIG. 3.

The significant improvement in the scratch resistance is achieved at a mixing ratio of MgF₂ sol/ZrO₂ sol of 80/20. The transmission is still very good at up to approx. 98%.

### Determination of the Refractive Indices and Layer Thicknesses by Ellipsometry for Examples 2 and 3

| MgF₂ sol/Al₂O₃ sol | | |
|---|---|---|
| % by wt./% by wt. | n_{550 nm} | d |
| 100/0 | 1.253 | 75 nm |
| 90/10 | 1.279 | 82 nm |
| 80/20 | 1.292 | 74 nm |
| 70/30 | 1.305 | 70 nm |
| 0/100 | 1.330 | 181 nm |

| MgF₂ sol/ZrO₂ sol | | |
|---|---|---|
| % by wt./% by wt. | n_{550 nm} | d |
| 100/0 | 1.253 | 75 nm |
| 90/10 | 1.275 | 75 nm |
| 85/15 | 1.276 | 70 nm |
| 80/20 | 1.350 | 68 nm |
| 70/30 | 1.477 | 72 nm |
| 0/100 | 1.850 | 43 nm |

What is claimed is:

1. A process for producing a substrate having thereon an abrasion- and scratch-resistant coating with a low refractive index, which coating comprises magnesium fluoride and at least one oxide selected from oxides of metals and semimetals, wherein the process comprises applying to a substrate a coating composition which comprises (i) at least one of magnesium fluoride and a precursor thereof and (ii) at least one compound selected from oxides of metals and semimetals and precursors thereof, and heat-treating a resultant substrate.

2. The process of claim 1, wherein the coating composition is applied to the substrate by at least one of a coating process and a printing process.

3. The process of claim 1, wherein the resultant substrate is heat-treated at a temperature of from 100 to 600° C.

4. The process of claim 1, wherein the process further comprises providing the substrate with one or more identical or different layers at least one of before and after applying the coating composition to the substrate.

5. The process of claim 1, wherein the at least one compound (II) comprises at least one of ZrO₂, TiO₂, Al₂O₃, Ta₂O₅, and SiO₂.

6. The process of claim 1, wherein the at least one compound (II) comprises at least ZrO₂.

7. A coating composition for providing an abrasion- and scratch-resistant coating with a low refractive index, wherein the composition comprises (i) at least one of magnesium fluoride and a precursor thereof and (ii) at least one compound selected from oxides of metals and semimetals and precursors thereof.

8. The coating composition of claim 7, wherein the composition comprises a sol or a solution of (i) and a sol of (ii).

9. The coating composition of claim 7, wherein (i) and (ii) make up at least 80% by weight of a solids content of the composition.

10. A process for preparing the coating composition of claim 7, wherein the process comprises mixing a sol or a solution of (i) and a sol of (ii).

11. The process of claim 10, wherein the sol or solution of (i) is obtainable by reacting a magnesium compound with a fluorinated organic compound in an organic solvent.

12. The process of claim 11, wherein the fluorinated organic compound comprises a CF₃ group.

13. The process of claim 12, wherein the fluorinated organic compound comprises at least one of a ketone and a carboxylic acid.

14. The process of claim 13, wherein the fluorinated organic compound comprises trifluoroacetic acid.

15. The process of claim 11, wherein the magnesium compound comprises a magnesium alkoxide.

16. The process of claim 15, wherein the magnesium alkoxide comprises magnesium ethoxide.

17. The process of claim 11, wherein the organic solvent comprises an alcohol.

18. The process of claim 10, wherein the sol of (ii) is obtainable by hydrolyzing at least one of a hydrolyzable metal compound and a hydrolyzable semimetal compound.

19. The process of claim 18, wherein the sol of (ii) is obtainable by hydrolyzing at least one of a metal alkoxide and a semimetal alkoxide.

20. The process of claim 19, wherein the process further comprises incorporating at least one of a complexing agent and an adhesion promoter into the coating composition.
